(19) United States
(12) Patent Application Publication
(10) Pub. No.: US 2008/0210785 A1
(43) Pub. Date: Sep. 4, 2008

(54) WATER FEED PIPE FOR USE IN IRRIGATION

(76) Inventors: Fu-Jen Hou, Chiayi City (TW); Chen-Feng Hung, Chiayi City (TW); Chih-Hao Han, Chiayi Hsien (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/681,442

(22) Filed: Mar. 2, 2007

(51) Int. Cl. B05B 1/06

(52) U.S. Cl. 239/542

(57) ABSTRACT

A water feed pipe for use in irrigation comprises a main pipe including a plurality of side pipes formed around the peripheral wall thereof, and a plurality of through holes arranged on the peripheral wall thereof, each of the side pipes including a plurality of outlets formed on the peripheral wall thereof, such that water can be introduced into the side pipes through the main pipe so as to supply water for irrigating croppers.

### BACKGROUND OF THE INVENTION

1. Field of the Invention

The present invention relates to a water feed pipe, and more particularly to a water feed pipe for use in irrigation that water can be introduced into the side pipes through the main pipe so as to supply water for irrigating croppers.

2. Description of the Prior Arts

Sun, air and water are indispensable factors for cropper growth, especially irrigation system for cropper has to be constructed by manual labor so as to provide a good growing condition.

In a conventional irrigation system, water feed pipes which are buried in soil have been gradually developed in recent days except water spray equipments so as to obtain a water supplying and saving purpose.

Such a conventional water feed pipe includes a cloth layer covered around the outer periphery thereof, and a plurality of outlets formed thereon, such that as water is fed into the water feed pipe, it flows out of the water feed pipe through the cloth layer and the outlets so that the soil surrounding the water feed pipe can absorb water to irrigate croppers. However, because the cloth layer will easily become decayed and hardened with time, a jam problem for the outlets of the water feed pipe occurs to seriously influence the irrigation effect.

The present invention has arisen to mitigate and/or obviate the afore-described disadvantages.

### SUMMARY OF THE INVENTION

The primary objective of the present invention is to provide a water feed pipe for use in irrigation, which the soil surrounding the water feed pipe can absorb sufficient water, and can not plug the outlets of the water feed pipe.

The water feed pipe for use in irrigation in accordance with the present invention comprises a main pipe including a plurality of side pipes formed around the peripheral wall thereof, and a plurality of through holes arranged on the peripheral wall thereof and communicating with the side pipes respectively. Each of the side pipes includes a plurality of outlets formed on the peripheral wall thereof, and the diameter of the outlet is less than that of the through hole.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is an exploded view of a water feed pipe for use in irrigation in accordance with the present invention;

FIG. 2 is a perspective view of the water feed pipe for use in irrigation in accordance with the present invention;

FIG. 3 is a cross sectional view of the water feed pipe for use in irrigation in accordance with the present invention;

FIG. 4 illustrates the application of the water feed pipe for use in irrigation of the present invention;

FIG. 5 is a cross sectional view of illustrating the water feed pipe for use in irrigation is in a water flowing state.

### DETAILED DESCRIPTION OF THE PREFERRED EMBODIMENT

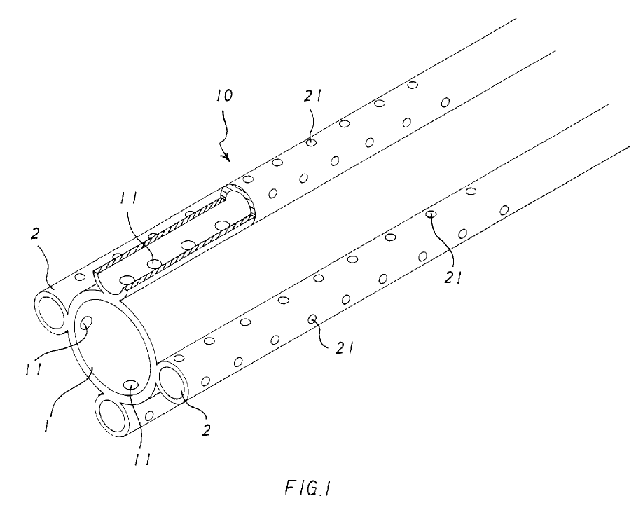

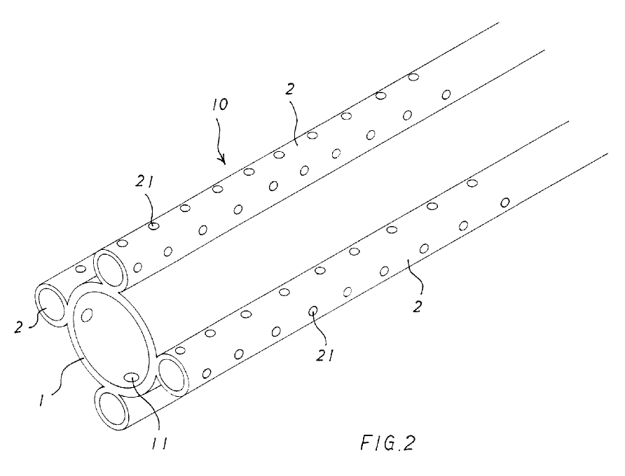

Referring to FIGS. 1 and 2, a water fed pipe for use in irrigation in accordance with the present invention comprises a main pipe 1 including a plurality of side pipes 2 formed around the peripheral wall thereof, and a plurality of through holes 11 arranged on the peripheral wall thereof and communicating with the side pipes 2 respectively. Each of the side pipes 2 includes a plurality of outlets 21 formed on the peripheral wall thereof.

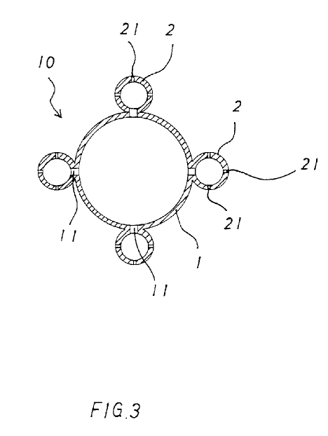

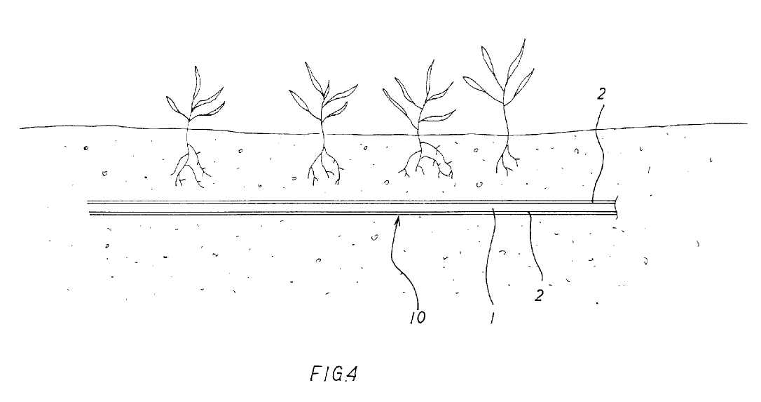

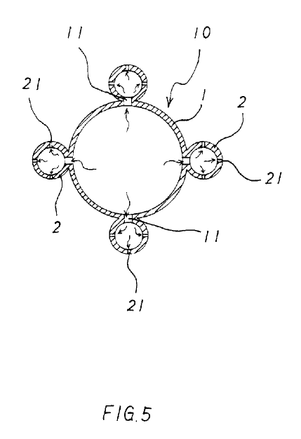

In the application, water is initially feed into and then quickly filled with the main pipe 11 as illustrated in FIGS. 3 and 4, and while the water flows in the main pipe 1, a part of it may be further led into the side pipes 2 through the through holes 11. After the main pipe 1 has enough water pressure therein due to the fed water, the water is fully filled with the side pipes 2 as shown in FIG. 5. It is to be noted that the diameter of the outlet 21 is less than that of the through hole 11, such that the pressure of the flowing water through the outlet 21 is decreased so that the soil surrounding a water feed pipe 10 can absorb sufficient water, and the outlet 21 can prevent being stuck by the soil, thereby effectively solving a jam problem for the water feed pipe 10.

Furthermore, in order to lower the cost of the water feed pipe 10, the main pipe 1 of the water feed pipe 10 may only include one sole side pipe 2 formed around the peripheral wall thereof.

The invention is not limited to the above embodiment but various modifications thereof may be made. It will be understood by those skilled in the art that various changes in form and detail may made without departing from the scope and spirit of the present invention.

What is claimed is:

1. A water feed pipe for use in irrigation comprising:
a main pipe including a plurality of side pipes formed around the peripheral wall thereof, and a plurality of through holes arranged on the peripheral wall thereof, each of said side pipes including a plurality of outlets formed on the peripheral wall thereof.

2. The water feed pipe for use in irrigation as claimed in claim 1, wherein the diameter of said outlet is less than that of said through hole.

3. The water feed pipe for use in irrigation as claimed in claim 1, wherein said main pipe may only include one sole side pipe formed around the peripheral wall thereof.

4. The water feed pipe for use in irrigation as claimed in claim 2, wherein said main pipe may only include one sole side pipe formed around the peripheral wall thereof.
